(19) United States
(12) Patent Application Publication
(10) Pub. No.: US 2016/0023332 A1
(43) Pub. Date: Jan. 28, 2016

(54) OFFSET WRENCH AND POWER TRANSMISSION MEANS

(71) Applicant: Gerard LEVESQUE, Fort Pierce, FL (US)

(72) Inventor: Gerard LEVESQUE, Fort Pierce, FL (US)

(21) Appl. No.: 14/806,265

(22) Filed: Jul. 22, 2015

Related U.S. Application Data
(60) Provisional application No. 62/028,394, filed on Jul. 24, 2014.
(60) Provisional application No. 62/063,076, filed on Oct. 13, 2014.

(51) Int. Cl. B25B 17/02; F16H 49/00

(52) U.S. Cl. CPC B25B 17/02; F16H 49/00

(57) ABSTRACT

The present invention is tool for transmitting torque from one end of the tool to the other comprising a housing having an input sprocket and an output sprocket connected by a race containing ball bearings whereby torque applied to one sprocket is transmitted to the other sprocket via movement of the ball bearings. The tool can be configured as a wrench for removal of nuts, bolts and screws or as a drive transmission means for applying torque from a source of rotary motion to a device requiring rotary motion to drive it.

### CROSS-REFERENCE TO RELATED APPLICATIONS

This application claims priority to U.S. provisional patent application No. 62/028,394 filed on Jul. 24, 2014 and to U.S. provisional patent application No. 62/063,076 filed on Oct. 13, 2014. All references cited herein are expressly incorporated by reference.

### BACKGROUND OF THE INVENTION

Removing nuts and bolts from locations with limited access can be a daunting task for a mechanic. Typically, the use of sockets with extensions and universal joints are used to reach the head of the nut or bolt. However, such tools are limited in the amount of torque they can apply and sockets are prone to slipping or stripping when used at an angle with high torque.

In the past tool makers tried to overcome the limitations of using sockets and extensions by creating flat chain driven extensions having a housing with a geared/sprocket means for receiving power from a ratchet at one end connected by a chain to a geared/sprocket means for transmitting the power to a socket at the other end. These devices worked acceptably well for low torque applications but were not sufficiently robust to work with impact wrenches. When subject to high torque the chains or gears would break or jam.

There is also a need in the art for a drive mechanism which transfers mechanical power reliably from a source to a point at which the power is needed. The technology herein is also applicable as a drive mechanism to replace chains, gears, and/or belts.

There is a need in the art for a wrench capable of delivering high torque to a remote location for loosening or tightening nuts and bolts.

### BRIEF DESCRIPTION OF THE FIGURES

FIG. 1 shows the wrench of the present invention.

FIG. 2 shows a cut away of the bottom casing and the top casing.

FIG. 3 shows a sprocket.

FIG. 4 shows s cutaway view of the present invention using roller bearings.

FIG. 5 shows a sprocket with roller bearings.

FIG. 6 shows a side view of roller bearings lined up.

FIG. 7 shows an embodiment of the present invention used as a power transmission.

FIG. 8 is a cutaway view of the power transmission shown in FIG. 7.

FIG. 9 is an embodiment of the power transmission showing tubing for the track.

FIG. 10 is an embodiment for power transmission showing flexible tubing.

### DETAILED DESCRIPTION OF THE INVENTION

### Offset Wrench

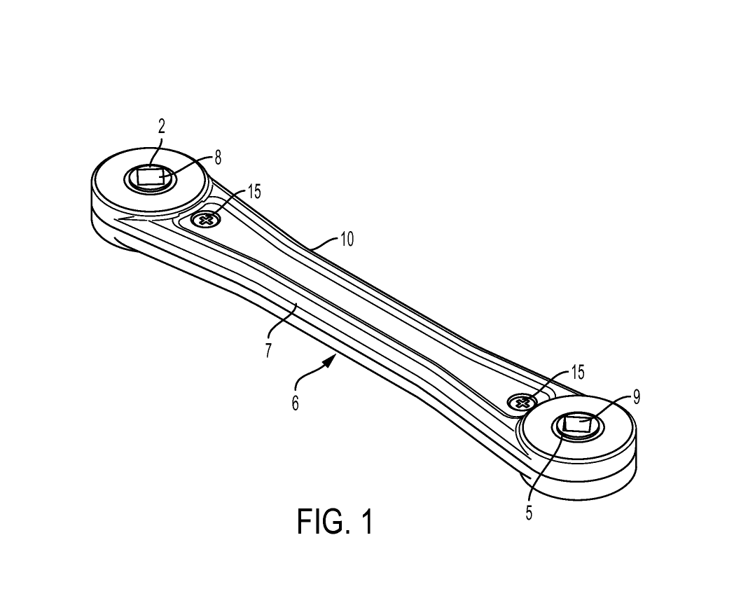

Referring to FIGS. 1-3, the present invention comprises a wrench 10 designed to internally transmit/impart torque applied at one end of the wrench to the opposite end of the wrench, respectively, without having to move/turn the wrench casing. The wrench 10 has a bottom casing 6 and a top casing 7. The top casing 7 and bottom casing 6, when mated/joined together, have an internal, continuous loop track channel 4; and two recesses 16, one at each end of the wrench for holding sprockets 2 and 5, respectively. A cross-section of the continuous loop track channel 4 will show a circular or square channel opening which is sized to fit a ball bearing. The sprockets are sized to fit into each respective recess 16 and sized to capture and retain ball bearings 3 which fill the entire length of the continuous loop track channel 4. The bearing should touch each other within the track. The track channel 4 is sized to snugly hold the ball bearings but is of sufficient size that it does not create unnecessary friction on the ball bearings 3.

Referring to FIGS. 1-3, the loop track channel 4 is continuous around the inside perimeter of the casing such that all the ball bearings will completely fill the track channel and will move around the entire distance/loop of the track channel. An input sprocket 5 is located at the proximal end of casing in a recess 16 which places the opening of the input sprocket 5 in line with track 4 such that ball bearings 3 from the track can enter the sprocket 5 from the track 4 and exit the sprocket 5 back onto the track 4.

The distal end houses the output sprocket 2 which fits in a second identical recess 16 which places the opening of the output sprocket 2 in line with track 4 such that ball bearings 3 from the track can enter the sprocket 2 from the track 4 and exit the sprocket 2 back onto the track 4.

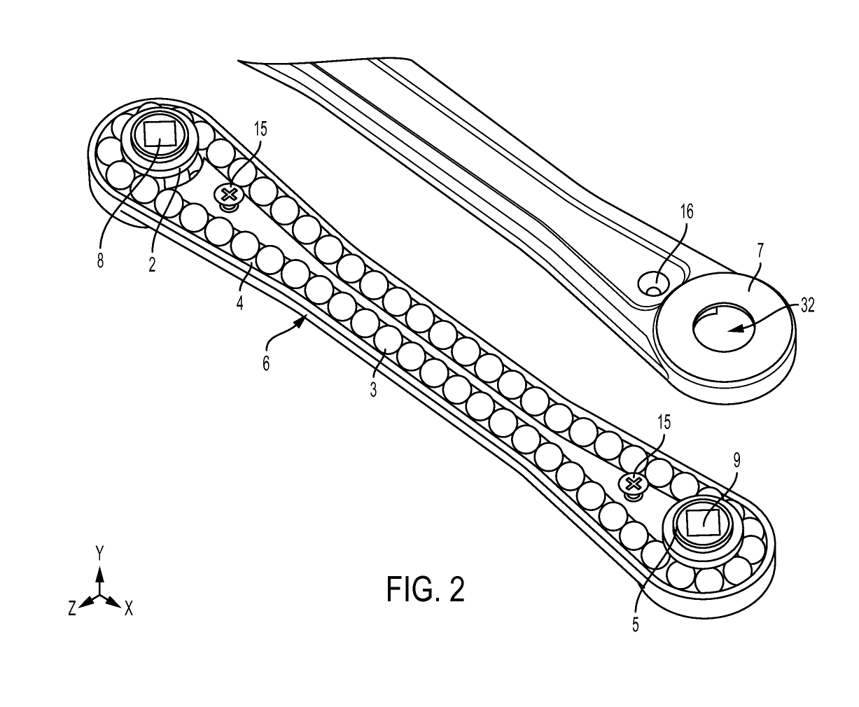

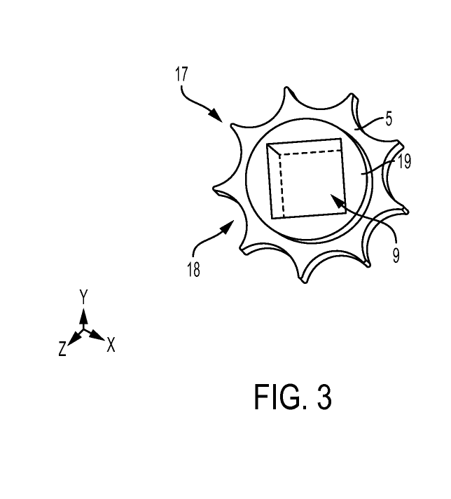

FIGS. 2 and 3 provide a closer view of the input sprocket 5 with the bearings 3 inserted into recesses 30 in the sprocket. In one embodiment the sprockets have a central circular raised section 31 to match an opening 32 in the casings such that the raised section 31 fits inside the opening 32 of the casings and the sprocket is thereby held in place by the casings when assembled.

In some applications, the casings 6 and 7 and the sprockets are separated by bearings to reduce the friction between the sprockets and casing. The bearings can be ball bearings, thrust bearings, roller bearing, low friction polymers, Teflon surfaces or any means known in the art for reducing friction between sliding or rotating surfaces. In some embodiments it may be sufficient to grease the surfaces of the sprocket and casing to reduce the friction.

Referring to the figures, rotational torque applied to input sprocket 5 causes the ball bearings 3 to move in the track channel 4 transmitting/imparting force to turn output sprocket 2.

Input sprocket 5 can be configured to accept any suitable means of rotational force. In the embodiments shown, the input 5 sprocket is sized to hold a ⅜ square drive mechanism. One of skill in the art will appreciate that the geometry of the input sprocket drive configuration can vary depending on the application and could be any shape which will allow engaging with the sprocket without slipping when torque is applied. The input sprocket can be female as shown or could be male. The source of torque would therefore be either male or female as required to inversely match the input sprocket.

The output sprocket 2 can have a female configuration sized to directly fit a nut or the head of bolt. In another embodiment, the output sprocket 2 drive configuration has a square drive mechanism to fit common sockets and extensions. The drive mechanism can be male or female depending on the configuration of the sockets and extensions. In one embodiment the output sprocket 2 has a common ¼, ⅜ or ½ square female drive and is provided with a double male adapter of the same dimensions. One end of the male adapter fits into the sprocket 2 and the other end fits into a standard socket or an extension, such as would already be part of a mechanic's tool set. The use of drive means to fit existing tools reduces the number of wrenches of the present invention which must be kept in the tool box. Adapters can be created to fit any need.

In another embodiment, the adapters are sized on one end to fit the sprocket and on the other end include a socket, screwdriver bit, or other form of drive configuration. Such adapters could be sized to fit any desired screw drive or bolt head.

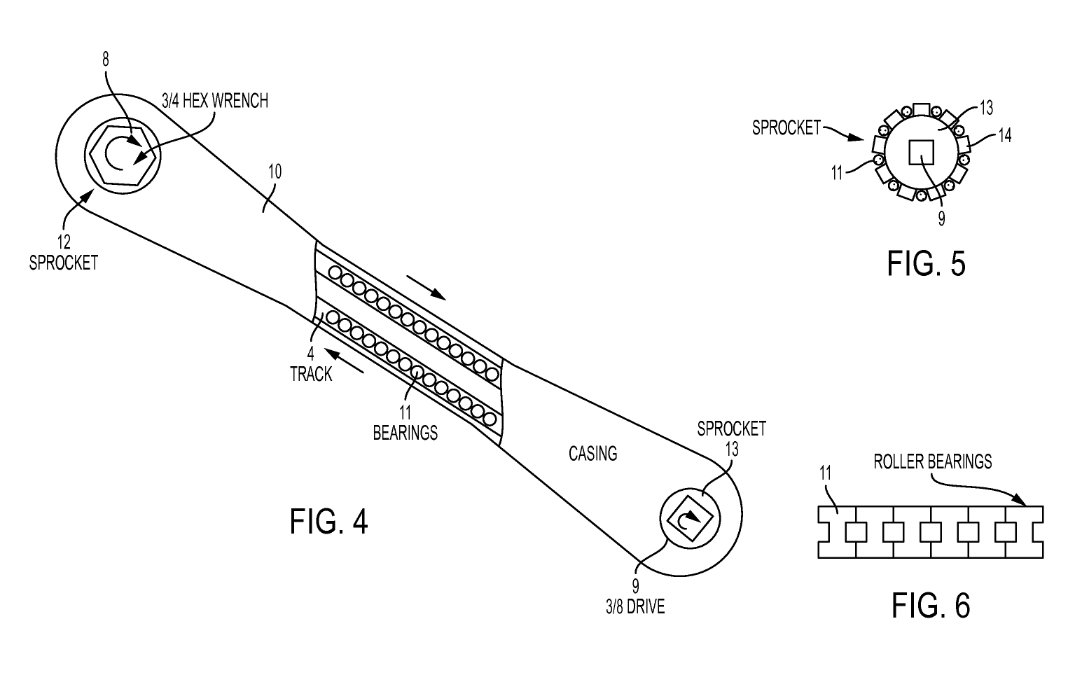

Referring to FIGS. 4-6, another embodiment of the present invention comprises a wrench 10 designed to internally transmit torque applied at one end which transmits/imparts that force to the opposite end of the wrench, respectively, without having to move/turn the wrench casing. The wrench 10 has a bottom casing 6 and a top casing 7. The top casing 7 and bottom casing 6, when mated/joined, have a continuous loop track channel 4 and two recesses 16, one at each end, for holding sprockets 5, 2 situated at opposite ends of the casing. The sprockets are sized to fit into the recesses 16 and are sized to capture and retain roller bearings 11. The track channel 4 is sized to snugly hold the roller bearings but is of sufficient size that it does not create unnecessary friction on the roller bearings 11.

Referring to FIGS. 4-6, the track 4 is a continuous loop channel around the inside perimeter of the casing such that all the roller bearings will move around the entire distance of the loop track channel. An input sprocket 5 is located at the proximal end of casing in a recess 16 which places the opening of the sprocket in line with track 4 such that roller bearings 11 from the track can enter the sprocket 5 from the track 4 and exit the sprocket 5 back onto the track 4.

The distal end houses the output sprocket 2 which fits in a second recess 16 which places the opening of the sprocket in line with track 4 such that roller bearings 11 from the track can enter the sprocket 2 from the track 4 and exit the sprocket 2 onto track 4.

In some applications, the casing 6 and 7 and the sprockets are separated by bearings to reduce the friction between the sprockets and casing. The bearings can be ball bearings, thrust bearings, roller bearings, low friction polymers, Teflon surfaces or any means known in the art for reducing friction between sliding or rotating surfaces. In some embodiments it may be sufficient to grease the surfaces of the sprockets and casing to reduce the friction.

Referring to the figures, rotational torque applied to input sprocket 5 causes the roller bearings 11 to move in track channel 4 imparting force to turn output sprocket 2.

Input sprocket 5 can be configured to accept any suitable means of rotational force. In the embodiments shown, the sprocket is sized to hold a ⅜ square drive mechanism 9. One of skill in the art will appreciate that the geometry of the input sprocket can vary depending on the application and could be any shape which will allow engaging with the sprocket without slipping when torque is applied. The input sprocket can be female as shown or could be male. The source of torque would either be male or female as required to inversely match the input sprocket 5.

The output sprocket 2 can have a female configuration sized to directly fit a nut or the head of bolt. In another embodiment, the output sprocket 2 has a square drive mechanism to fit common sockets and extensions. The drive mechanism can be male or female depending on the configuration of the sockets and extensions. In one embodiment the output sprocket 2 has a common ¼, ⅜ or ½ square female drive and is provided with a double male adapter of the same dimensions. One end of the male adapter fits into the sprocket 2 and the other end fits into a standard socket or an extension, such as would already be part of a mechanic's tool set. The use of drive means to fit existing tools reduces the number of wrenches of the present invention which must be kept in the tool box. Adapters can be created to fit any need.

In another embodiment, the adapters are sized on one end to fit the sprocket and on the other end include a socket, screwdriver bit, or other form of drive configuration. Such adapters could be sized to fit any desired screw drive or bolt head.

One of skill in the art will appreciate that the present invention can also be used as a drive transmission in place of belts and pulleys, chains and sprockets and gears and shafts. In such an embodiment the input sprocket or sprocket is connected to a rotating source of power such as a crankshaft or other turning shaft and the output sprocket or sprocket is attached to the shaft of a device needing to be turned. Such a drive mechanism could be used to turn axles of any type including alternators, water pumps, hydraulic pumps or anything which rotates.

### Power Transmission

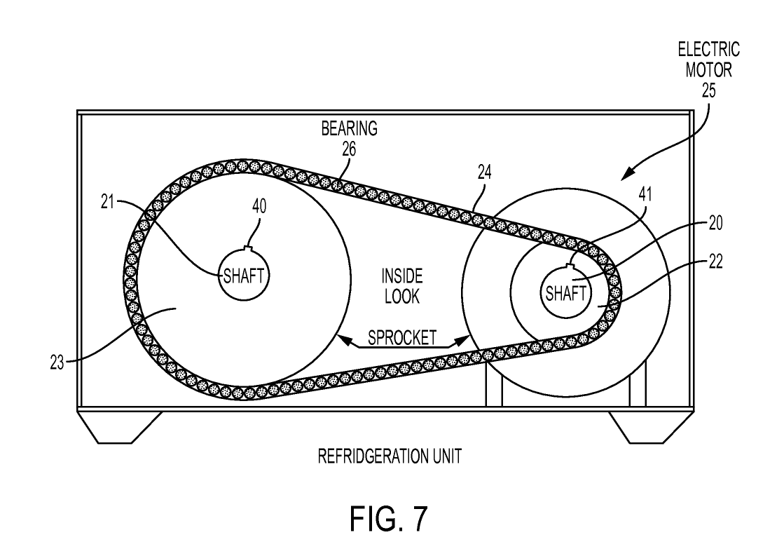

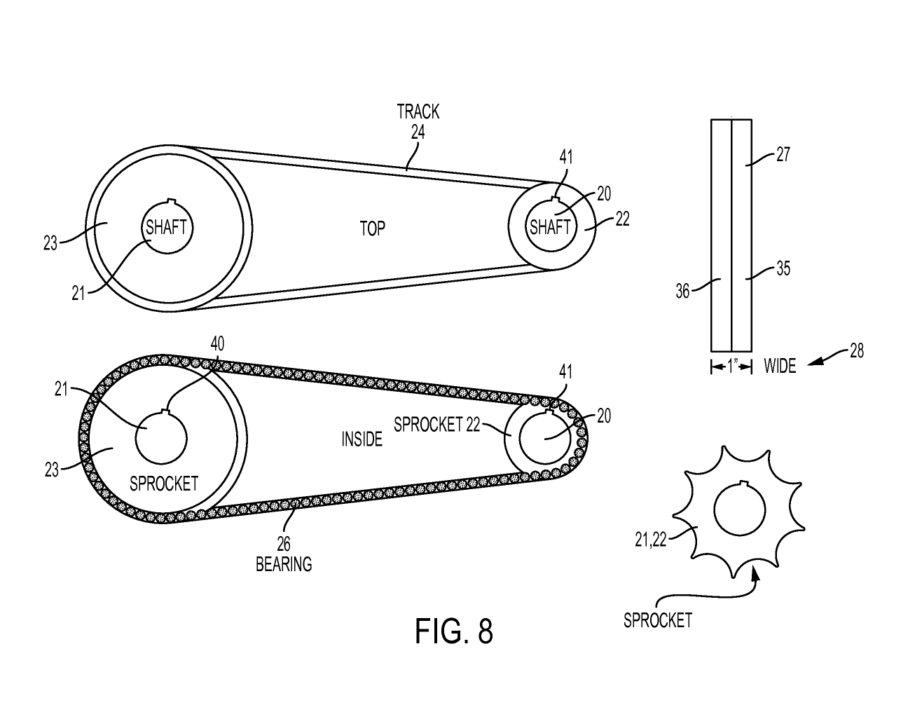

Referring now to FIGS. 7-10, the technology of the present invention can be used to replace belts, chains and gears which transfer power from a rotational power source to a device requiring power. Such applications include power tools, compressors, automotive accessory drives, appliances, any application where power is needed to be transferred from a rotating source. The power transmission device of the present invention will reduce maintenance associated with belts or chains and reduce the complexity of geared systems. Further, the designs of the present invention may be configured to transmit power to locations which a belt or chain cannot be used due to 3-dimensional turns or because the source of power and the device to be powered are not in the same plane.

Sprocket 22 is fit to output shaft 20 of the power source 25. The sprocket 22 may be fit via a press fit or have a key-way 41. A second sprocket 23 is fit to the device to be powered via a shaft 21. The sprocket may be press fit or have a key-way 40. The two sprockets 22 and 23 contain recesses 45 for holding a ball bearing 26. The sprockets are located at opposite ends of a casing 27 having a recessed track 24 which provides a path for the ball bearings to move between the two sprockets in a circular fashion. In one embodiment, the casing 27 is linear and is preferably comprised of a right half 36 and a left half 35 which when mated together house the sprockets 22 and 23. At least one half of the casing has holes through which a shaft may pass into the sprockets. The track 24 is filled with ball bearings 26 such that motion of a sprocket 22 induces motion in the ball bearings and that motion is transferred to sprocket 23.

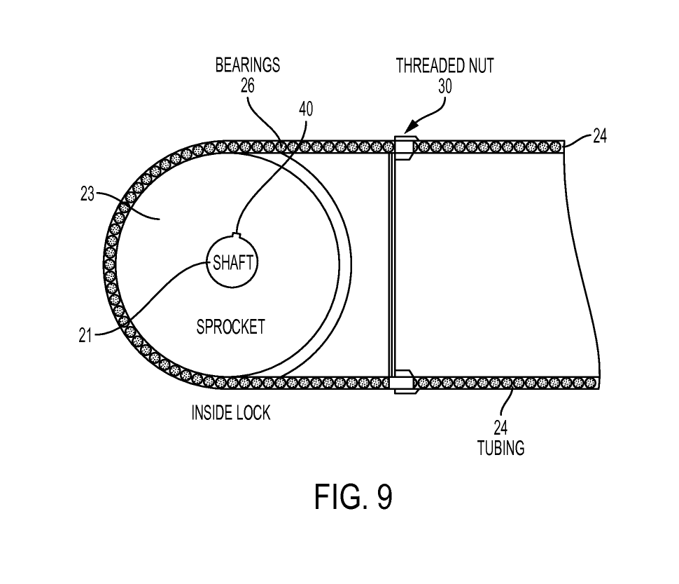

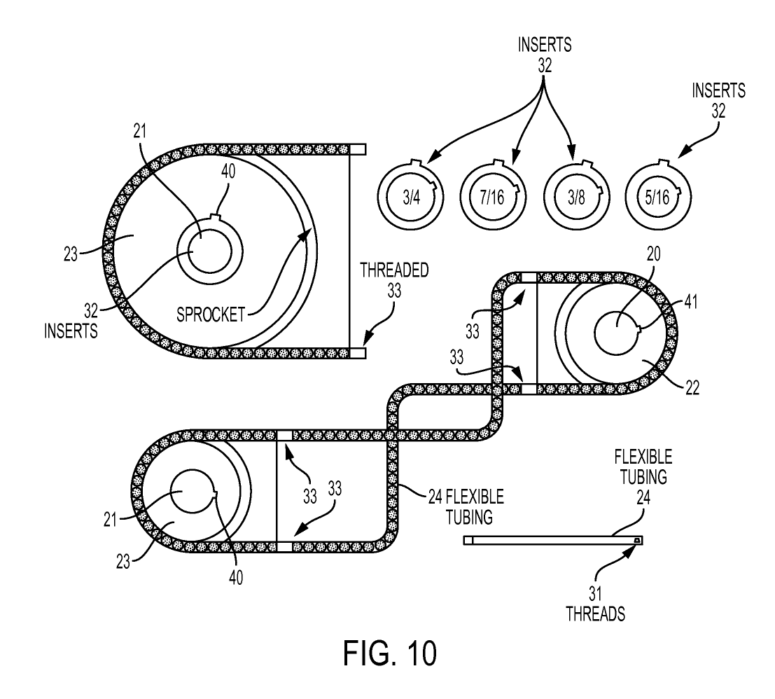

Referring to FIGS. 9 and 10, in another embodiment, the sprockets 22 and 23 each have their own dedicated casing comprising a track 24. The tracks between the casings are connected with tubing 29 which allows the distance between the sprockets to be varied by changing the length of the tubing. Further, the tubing 24 may be bent to allow it to avoid obstructions and to transmit power when the sprockets are not in a linear relationship to each other. The tubing 24 used should be sufficiently strong to withstand the torque applied to the ball bearings. In some instances, flexible polymer tubing may have sufficient strength, while in other instances metal tubing will be required. The tubing 24 can be attached to the casing through threads, couplings or compression fittings. When bending the tubing around objects, care needs to be taken to ensure that the inner diameter of the tubing is not reduced below the diameter of the ball bearings 26.

Referring to FIG. 10, the inner diameter of a sprocket 21, 22 can be made of a uniform dimension and sized to a shaft through the use of inserts 32. The drive system could be supplied as a kit with housings, tubing, ball bearings and inserts to allow it to be retrofit to existing installations.

Depending on the application and materials, the tracks, sprockets and ball bearings may or may not need to be lubricated.

The wrench and drive mechanism can be built to handle 500 pounds of torque or more.

One of skill in the art will appreciate that substantial deviations can be made from the invention as specifically disclosed without deviating from the spirit of the invention.

I claim:

1. A wrench comprising:
a. a casing having recesses to hold an input sprocket and an output sprocket, the input sprocket having a means for receiving an input torque and the output sprocket having a means for delivering an output torque, each sprocket having a plurality of teeth for holding a bearing, wherein the sprockets turn within the casing;
b. the casing having a continuous loop track channel sized to house ball bearings;
c. a plurality of bearings sufficient to fill the continuous loop track channel including the recesses in the input and output sprockets.

2. The wrench according to claim 1 wherein a bearing is inserted between the sprocket and casing.

3. The wrench according to claim 1 wherein the bearings are ball bearings or roller bearings.

4. The wrench according to claim 1 wherein the input sprocket is sized to fit a conventional tool drive.

5. The wrench according to claim 4, wherein the tool drive is a square drive.

6. The wrench according to claim 2 wherein the bearing is a plurality of ball bearings, thrust bearings, roller bearings, or a polymer bearing.

7. The wrench according to claim 1 wherein the output sprocket is sized to fit a conventional tool drive.

8. The wrench according to claim 7 wherein the conventional tool drive is a square drive.

9. The wrench according to claim 7 wherein the output sprocket has a female recess sized to fit a nut or bolt.

10. The wrench of claim 7 wherein the output sprocket is sized to fit an adapter.

11. A method of turning a nut or bolt in a remote location comprising:
a. entering an input torque into an input sprocket housed in a casing;
b. transferring the input torque from the input sprocket to a plurality of bearings housed within a track channel in the casing;
c. transferring the input torque from the plurality of bearings to an output sprocket;
d. transferring the input torque to a nut or bolt via the output sprocket.

12. The method of claim 11 wherein the input torque is delivered with an impact wrench, a ratchet, or a breaker bar.

13. The method of claim 11 wherein the bearings are ball bearings.

14. The method of claim 11 wherein the bearings are roller bearings.

15. The method of claim 11 wherein the torque is applied with a conventional tool drive.

16. The method according to claim 15 wherein the conventional tool drive is a square drive.

17. The method according to claim 11 wherein the output sprocket has a female recess sized to fit a nut or bolt.

18. The method of claim 11 wherein the output sprocket delivers torque through an adapter.

19. A mechanism for transferring power on a machine comprising:
a. A casing having recesses to hold an input means and an output means, the input means having a means for receiving an input torque and the output means having a means for delivering an output torque, each input and output means having a plurality of recesses around it for holding a bearing, wherein the input and output means turn within the casing;
b. a continuous loop track channel sized to house bearings;
c. a plurality of bearings sufficient to fill the continuous loop track channel including the recesses in the input and output means; wherein when an input torque is applied to the input means rotates and transfers the torque to the ball bearings which transfer the torque to the output means.

20. The mechanism for transferring power of claim 19 wherein the continuous loop track is part of the casing.

21. The mechanism for transferring power of claim 19 wherein the continuous track is comprised of tubing.

22. The mechanism for transferring power of claim 19 wherein the sprockets are sized to a shaft via an insert.
